(19) United States
(12) Patent Application Publication
(10) Pub. No.: US 2007/0016515 A1
(43) Pub. Date: Jan. 18, 2007

(54) MortgageOps

(75) Inventor: Reginald Bernard Knight, West Palm Beach, FL (US)

Correspondence Address: Reginald B. Knight, 1096 Cameo Circle, West Palm Beach, FL, 33417, US

(73) Assignee: Reginald Knight

(21) Appl. No.: 11/180,366

(22) Filed: Jul. 14, 2005

(51) Int. Cl. G06Q 40/00

(52) U.S. Cl. 705/38

(57) ABSTRACT

MortgageOps a mortgage lending processing system is disclosed. The mortgage lending system processes and sort premium loans from discounted loans while validating data, documents and documentation during each process.

### FIELD OF THE INVENTION

The present invention relates generally to processing loans, and more particularly to a loan processing solution and a method for separating premium loans from discounted loans while validating data, documents and documentation.

### BACKGROUND OF THE INVENTION

In traditional lending loans are processed when they are originated and after they have been closed. The origination process is normally referred to as front-end processing and the after closed process is normally referred to as closed-end processing or the due diligence process. The inflexibility of this kind of loan processing, as well as the inability to process loans only once and have data control, has led to a rising demand to develop a loan processing system and method for processing loans for a premium market along with the existing discounted market. Loan processing traditionally doesn't have a standard process and this has crippled the development of a new market.

### SUMMARY OF INVENTION

The implementation of the invention is a loan processing system. The embodiment of the loan processing system comprises a registration process, an underwriting process, a processing process, a closing process, a compliance process, a funding process, a collateral process, a servicing process, a compliance process 2 and a shipping process. In this particular embodiment these components or processes are arranged in this specific order to achieve its goal. In each process the data, documents and documentation will be validated during processing.

The advantage of the arrangement of these components for this invention is that this arrangement will separate and differentiate premium loans from discounted loans. The system will do due diligence and validate data during processing maintaining data and processing control causing the loan to be processed only once eliminating the closed-end or due diligence process.

The primary benefit of this processing system is to create a standardized way to process loans that will create a new market for premium loans and sustain the existing discounted market in one systematic processing system with processing and data control.

### BRIEF DESCRIPTION OF THE DRAWINGS

For a more complete understanding of the invention and the advantage thereof, reference is now made to the following description taken in conjunction with accompanying drawings, wherein like reference numerals represent like parts, in which:

FIG. 1 is the diagram of the loan processing system in accordance with the invention;

FIG. 1.1 is a diagram of the registration process;

FIG. 1.2 is a diagram of the underwriting process;

FIG. 1.3 is a diagram of the processing process;

FIG. 1.4 is a diagram of the closing process;

FIG. 1.5 is a diagram of the compliance process;

FIG. 1.6 is a diagram of the funding process;

FIG. 1.7 is a diagram of the collateral process;

FIG. 1.8 is a diagram of the servicing process;

FIG. 1.9 is a diagram of the compliance process 2; and

FIG. 1.10 is a diagram of the shipping process;

### DETAILED DESCRIPTION OF THE INVENTION

In the following detailed description of the preferred embodiments, reference is made to the accompanying drawings which form a part of hereof, and in which is shown by way of illustration specific preferred embodiments in which the invention may be practiced. These embodiments are described in sufficient detail to enable those skilled in the art to practice the invention and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

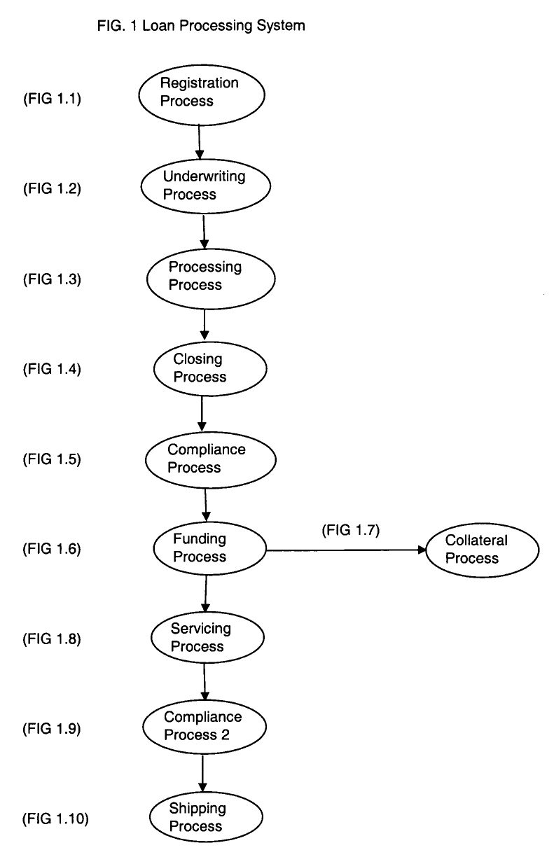

FIG. 1 is an example of the embodiment of the loan processing system. In this embodiment, the system comprises a registration process FIG. 1.1 that flows to the underwriting process FIG. 1.2 that flows to the processing process FIG. 1.3 that flows to the closing process FIG. 1.4 that flows to the compliance process FIG. 1.5 that flows to the funding process FIG. 1.6 that flows to the collateral process FIG. 1.7 that flows to the servicing process FIG. 1.8 that flows to the compliance process 2 FIG. 1.9 that flows to the shipping process FIG. 1.10.

Registration Process FIG. 1.1 is comprised of data used to register a loan. This data is entered through a user registration interface that allows users to input information into the system, validate information and request necessary documents. The interface generally includes display and printer capability, but may also include such devices as a keyboard, voice recognition system, or any other suitable data input device.

Underwriting process FIG. 1.2 is comprised of data used to underwrite a loan. This data is entered through a user underwriting interface that allows users to input information into the system. The interface calculates and processes data to determine approval, denial or conditions of a loan status regarding the ability to repay aspect of the loan. The interface generally includes display and printer capability, but may also include such devices as a keyboard, voice recognition system, or any other suitable data input device.

Processing process FIG. 1.3 is comprised of data used to process a loan. This data is entered through a user processing interface that allows users to input information into the system, validate information and request necessary documents. The interface generally includes display and printer capability, but may also include such devices as a keyboard, voice recognition system, or any other suitable data input device.

Closing Process FIG. 1.4 is comprised of data and documents used to close a loan. The data is entered through a user closing interface that allows users to input information into the system, request necessary documents and validate information. The interface generally includes display and printer capability, but may also include such devices as a keyboard, voice recognition system, or any other suitable data input device.

Compliance Process FIG. 1.5 is comprised of data used to process a loan. The data is entered through a user compliance interface that allows users to input information into the system, calculate, request necessary documents and validate information. The interface generally includes display and printer capability, but may also include such devices as a keyboard, voice recognition system, or any other suitable data input device.

Funding process FIG. 1.6 is comprised of data used to fund a loan. The data is entered through a user funding interface that allows users to input information into the system and send wires to the appropriate entities. The interface generally includes display and printer capability, but may also include such devices as a keyboard, voice recognition system, or any other suitable data input device.

Collateral process FIG. 1.7 is comprised of data used to process collateral. The data is entered through a user collateral interface that allows users to input information into the system and validate the information. The interface generally includes display and printer capability, but may also include such devices as a keyboard, voice recognition system, or any other suitable data input device.

Servicing process FIG. 1.8 is comprised of data used to service a loan. The data is entered through a user servicing interface that allows users to input information into the system and setup billing to the appropriate entities. The interface generally includes display and printer capability, but may also include such devices as a keyboard, voice recognition system, or any other suitable data input device.

Compliance process 2 FIG. 1.9 is comprised of data used to process a loan. The data is entered through a user compliance interface that allows users to input information into the system and validate information. The interface generally includes display and printer capability, but may also include such devices as a keyboard, voice recognition system, or any other suitable data input device.

Shipping process FIG. 1.10 is comprised of data used to ship a loan. The data is entered through a user shipping interface that allows users to input information into the system and validate information. The interface generally includes display and printer capability, but may also include such devices as a keyboard, voice recognition system, or any other suitable data input device.

While the invention has been particularly shown and described in the forgoing detailed description, it will be understood by those skilled in the art that various other changes in form and detail may be made without departing from the spirit and scope of the invention.

1. The mortgage lending process comprises:
A registration process;
An underwriting process;
A processing process;
A closing process;
A compliance process;
A funding process;
A collateral process;
Servicing process;
A compliance process 2;
A shipping process;

2. The mortgage lending process according to claim 1, The above processes are systematically arranged to achieve a particular outcome.

3. The mortgage lending process according to claim 2, separates premium loans from discounted loans during the process.

4. The mortgage lending process according to claim 3, the systematically arranged processes differentiates a premium loan from a discounted loan.

5. The mortgage lending process according to claim 3, validates data, documents and documentation in each process.
